(19) United States
(12) Patent Application Publication
(10) Pub. No.: US 2026/0151928 A1
(43) Pub. Date: Jun. 4, 2026

(54) SLICING GUIDES FOR SETTING THICKNESS OF A SLICER

(71) Applicant: FRANK BRUNCKHORST CO, LLC, Sarasota, FL (US)

(72) Inventors: Adam Masucci, Parish, FL (US); Dale Foster, Bradenton, FL (US); Craig LaRosa, Sarasota, FL (US); James J. Olson, Sarasota, FL (US); Michael Evans, Sarasota, FL (US); Robert Owen Brady, Sarasota, FL (US); Ryan Carroll Donahue, Sarasota, FL (US); Matthew William Vergin, St Petersburg, FL (US); Anthony James Kelbert, Venice, FL (US)

(21) Appl. No.: 19/407,595

(22) Filed: Dec. 3, 2025

Related U.S. Application Data
(60) Provisional application No. 63/727,930, filed on Dec. 4, 2024.

(51) Int. Cl. B26D 7/26

(52) U.S. Cl. CPC B26D 7/2628; B26D 2210/02

(57) ABSTRACT

The slicing guide is utilized to safely and accurately set the thickness of a slicer. The slicing guide generally comprises a slicing guide rest that rests on the slicer and a slicing guide body extending from the slicing guide rest. The slicing guide rest is placed on an edge of the slicer, and the blade is adjusted until it contacts the slicing guide body or is aligned with a guide line on the slicing guide body. In some embodiments, the slicing guide may also be adjustable to accommodate a wide variety of slicer designs.

### CROSS-REFERENCE TO RELATED APPLICATIONS

This application claims priority to U.S. Provisional Patent Application Ser. No. 63/727,930, filed Dec. 4, 2024, the entire contents of which are hereby incorporated by reference in their entirety.

### FIELD OF THE INVENTION

The present invention relates to a slicing guide for setting the thickness on a slicer. More particularly, the present invention relates to a slicing guide that can be used to precisely and predictably set an exact thickness on a slicer regardless of model type.

### BACKGROUND

When cutting deli meat, a thickness must be set on the slicer before the meat is sliced. The thickness is important because different thicknesses are typically used for different purposes (e.g., sandwich making, cooking, etc.). If the thickness is incorrect, the sliced meat must often be discarded. Further, many customers are very particular about the thickness of deli and may refuse a purchase if the product is too thin or thick. Therefore, there exists a need for a slicing guide that can be used to consistently set the thickness on a slicer.

### SUMMARY

The slicing guide of the present invention is utilized to safely and accurately set the thickness of a slicer. The slicing guide is placed on an edge of the slicer, and the blade is adjusted until it contacts the slicing guide or is aligned with a guide line on the slicing guide. In some embodiments, the slicing guide may also be adjustable to accommodate a wide variety of slicer designs.

### BRIEF DESCRIPTION OF THE DRAWINGS

FIGS. 1-7 depict various views of a first embodiment of the slicing guide according to an embodiment of the invention.

FIGS. 8-14 depict various views of a second embodiment of the slicing guide according to an embodiment of the invention.

FIGS. 15-16 depict the steps used to set the thickness on a slicer utilizing the embodiments depicted in FIGS. 1-7 or FIGS. 8-14 according to an embodiment of the invention.

FIGS. 17-23 depict various views of a third embodiment of the slicing guide according to an embodiment of the invention.

FIGS. 24-25 depict the steps used to set the thickness on a slicer utilizing the embodiment depicted in FIGS. 17-23 according to an embodiment of the invention.

FIGS. 26-32 depict various views of a third embodiment of the slicing guide according to an embodiment of the invention.

FIGS. 33 & 34A-34B depict the steps used to set the thickness on a slicer utilizing the embodiment depicted in FIGS. 26-32 according to an embodiment of the invention.

FIGS. 35-42 depict various views of an adjustable version of the slicing guide according to an embodiment of the invention.

FIGS. 43-44 depict the steps used to adjust the slicing guide of FIGS. 35-42 according to an embodiment of the invention.

FIGS. 45-47 depict the steps used to set the thickness on a slicer utilizing the embodiment depicted in FIGS. 35-42 according to an embodiment of the invention.

FIGS. 49-50 depict various views of a fourth embodiment of the slicing guide according to an embodiment of the invention.

FIGS. 50-51 depict a slicing guide rest for use with the slicing guides depicted in FIGS. 26-50 according to an embodiment of the invention.

FIGS. 52-58 depict various view of an alternate embodiment of the sliding guide according to an embodiment of the invention.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

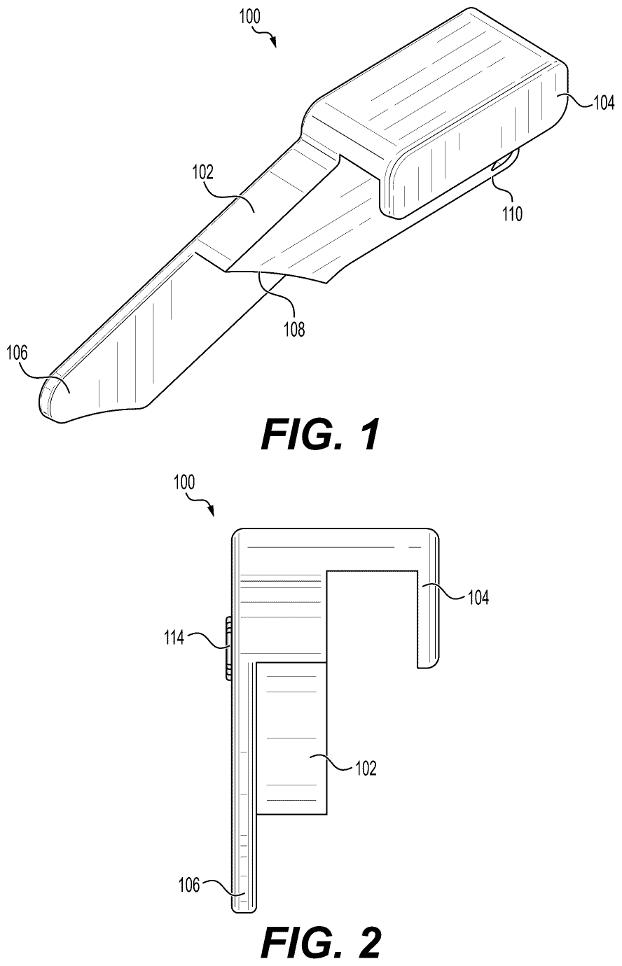

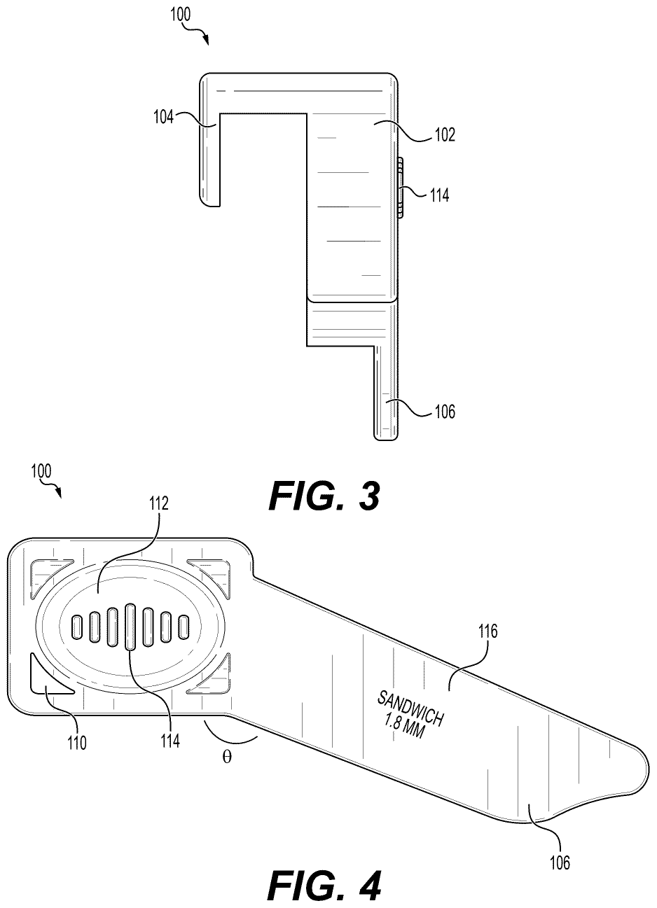

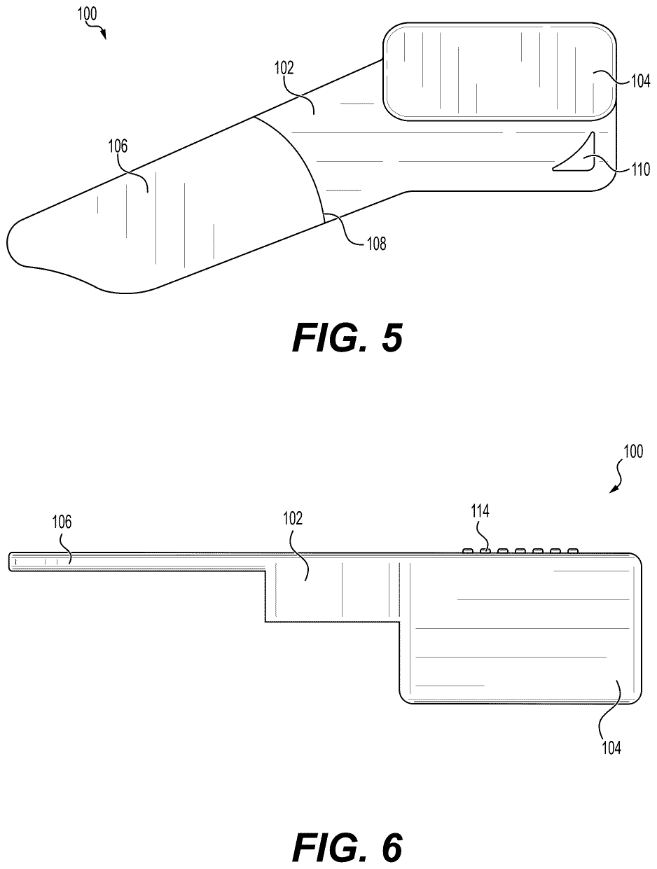

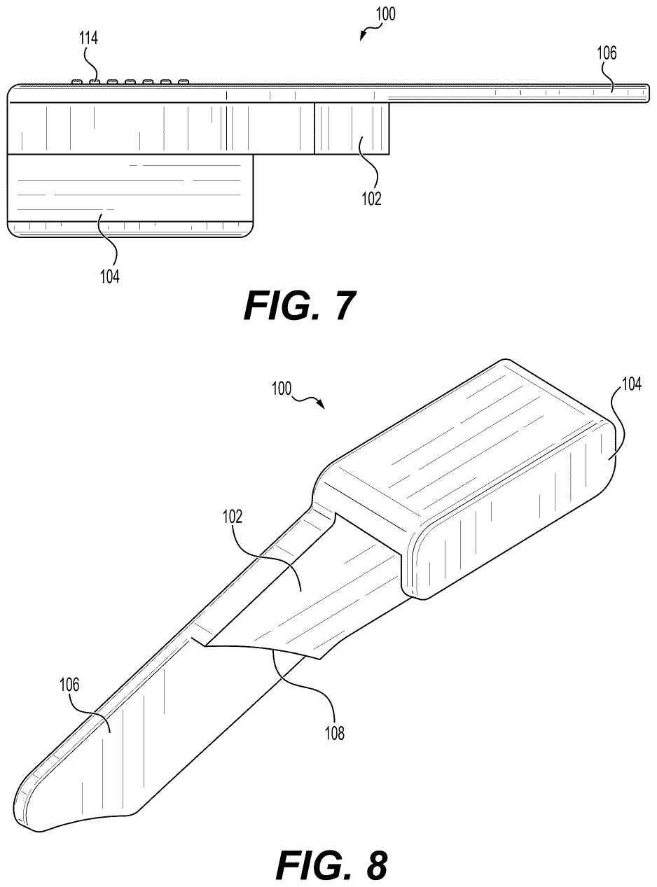

FIGS. 1-7 depicts an embodiment of slicing guide 100 according to an embodiment of the invention. As depicted, slicing guide 100 generally comprises slicing guide body 102, slicer hook 104, blade guide 106, curved face 108, thru hole 110, thumb well 112, finger grips 114, and thickness label 116. Preferably, slicing guide 100 has a unitary construction and can be formed from a suitable food-grade metal or plastic (e.g., stainless steel or polyethylene). Because the slicing guide 100 is designed to be used with a slicer 1502, it is preferably that the material is non-porous and hygienic to meet food safety requirements.

Slicer hook 104 is coupled to a top of slicing guide body 102 as depicted in FIGS. 1 and 2. As shown, slicer hook 104 comprises a lip and has a thickness sufficient to be placed over slicer edge 1504. It should be obvious to one of ordinary skill in the art that the thickness of slicer hook 104 can be varied to accommodate different models of slicers 1502.

A leading edge of slicing guide body 102 terminates at curved face 108 which has a curvature designed to align with a standard slicer blade 1506 (e.g., anywhere from an 8″ blade used on a light-duty slicer to a 20″ blade used on a heavy-duty slicer). In a preferred embodiment, the radius of curvature of curved face 108 is 200 mm to 500 mm. Blade guide 106 is coupled to a front edge of slicing guide body 102 adjacent to curved face 108. As will be described later, blade guide 106 contacts slicer blade 1506 when the thickness is being set on slicer 1502. The blade guide 106 is coupled at an angle θ that is approximately 160° degrees with a bottom edge of slicing guide body 102 as depicted in FIG. 4. The angle θ can be varied between 120-170° as long as the blade guide 106 extends over a portion of the slicer blade 1506.

Slicing guide body 102 may further comprise thru hole 110 (e.g., FIGS. 1 and 4) which can be used to hang slicing guide 100 when not in use (e.g., on a peg or nail) or may be used to join together multiple slicing guides 100, similar to how keys are joined on a key ring.

As shown in FIG. 4, a front surface of slicing guide body 102 may comprise thumb well 112 (e.g., a round or oval depression) and finger grips 114. The depicted finger grips 114 are a plurality of raised ridges of different height that can be used for additional friction against the thumb of a user when slicing guide 100 is being used. Since the user's fingers are in the vicinity slicer blade 1506 while it is being adjusted, finger grips 114 provide additional safety by preventing the user's fingers from slipping, especially since the slicing guide 100 can be held with just one hand while the slicer blade 1506 is adjusted with the other hand.

A thickness of curved face 108 can be identified using thickness label 116. That is, the thickness of curved face 108 is used to set the thickness used for slicer 1502. Thickness label 116 may be engraved/embossed on the surface of blade guide 106 or may be printed and adhered as is known in the art. The location of thickness label 116 may also be varied to different locations on slicing guide 100. Additional information, such as intended use (e.g., for sandwiches), may also be indicated on thickness label 116.

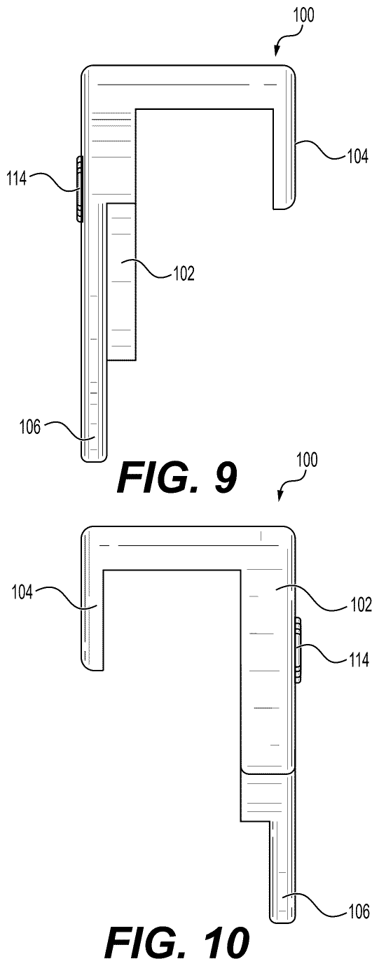

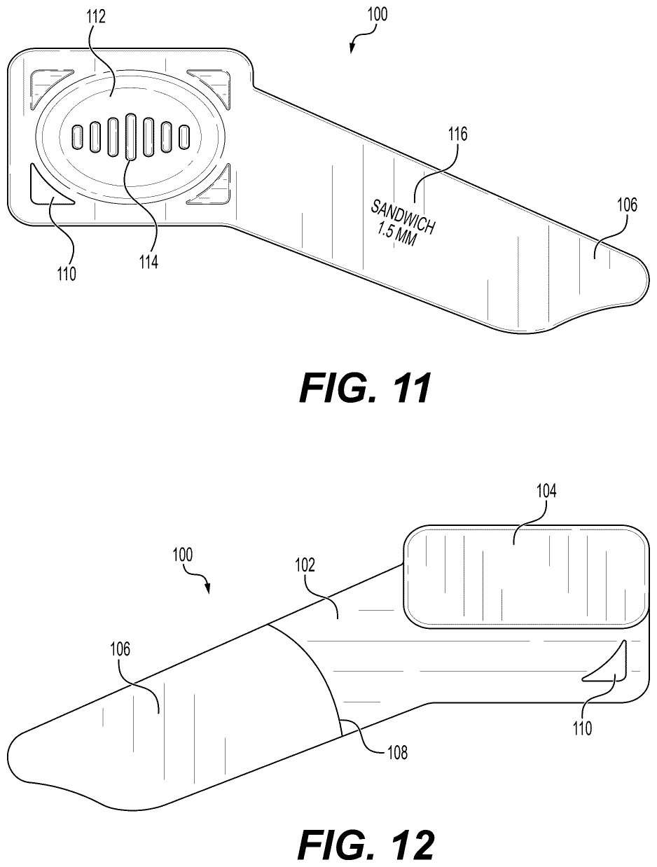

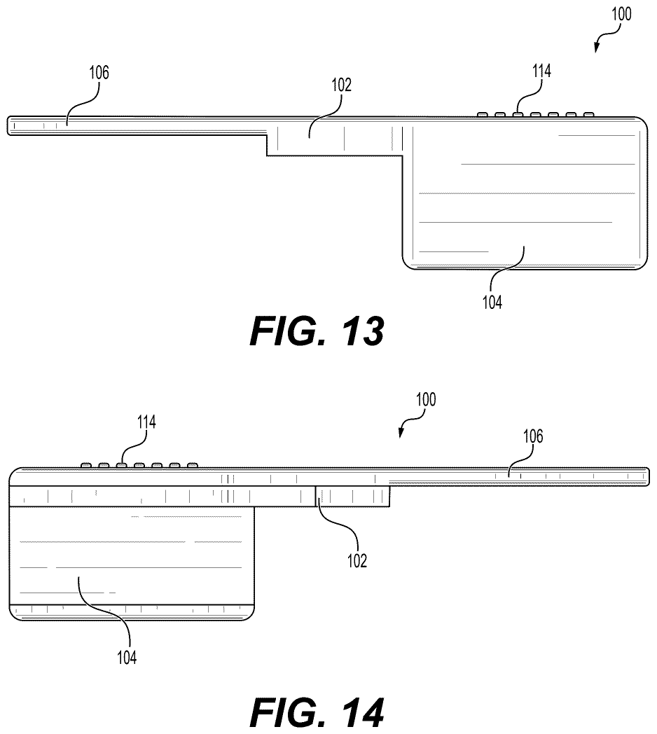

FIGS. 8-14 depict another embodiment of slicing guide 100. In this embodiment, the thickness depicted on thickness label (1.5 mm) 118 is less than that depicted in FIGS. 1-7 (1.8 mm). As best shown in FIG. 9, the thickness of curved face 108 is less than that of curved face 108 depicted in FIG. 2. The thickness of curved surface can be set for different slicing guides 100 that can be used to set slicer 1502 to different thicknesses (indicated on thickness labels 118). The width of slicer hook 104 is the same as depicted in FIG. 10, especially if being used on the same slicer 1502.

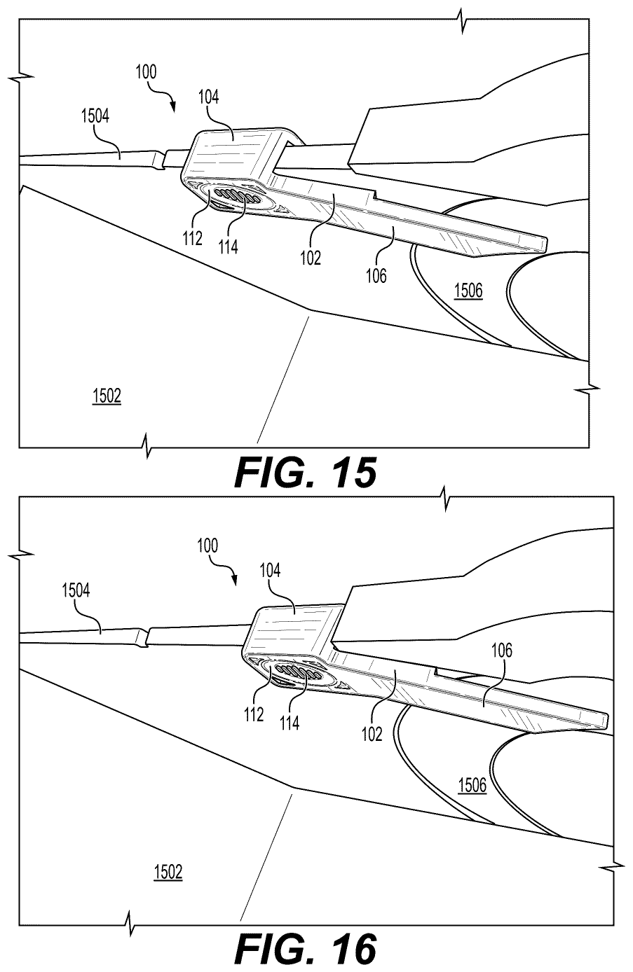

FIGS. 15-16 depict the steps utilized to set the thickness of slicer 1502 using the slicing guide 100 of FIGS. 1-7 or FIGS. 8-14. As shown in FIG. 15, the slicer hook 104 is placed over slicer edge 1504 and finger grips 114 are used to press the rear surface of slicing guide body 102 so slicing guide 100 remains in contact with slicer 1502. The positioning of slicing guide 100 can be adjusted until blade guide 106 extends over slicer blade 1506 and curved face 108 is in the vicinity of slicer blade 1506. The slicer blade 1506 is adjusted outwards until it contacts blade guide 106 as depicted in FIG. 16. Once slicer blade 1506 contacts blade guide 106, the thickness is set to the thickness indicated on thickness label 116.

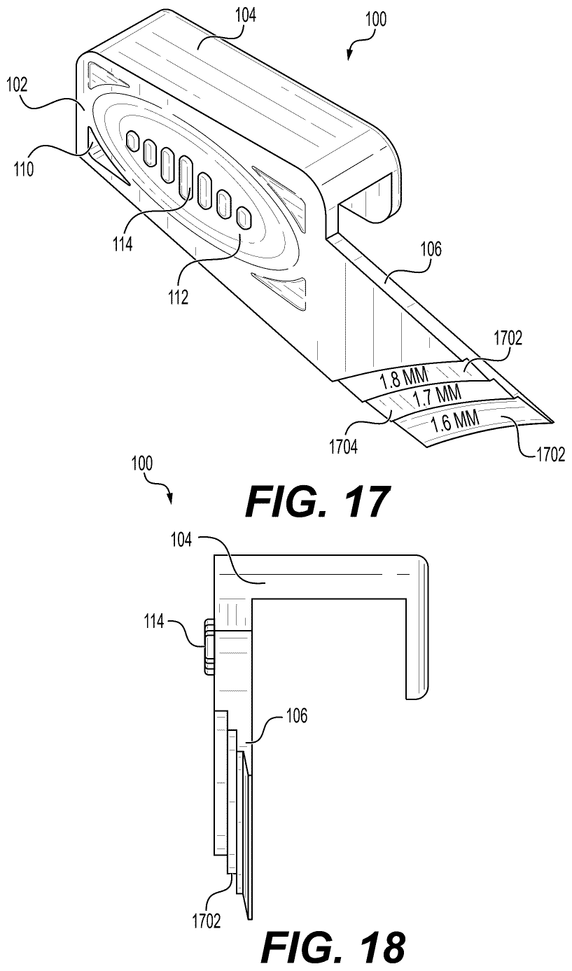

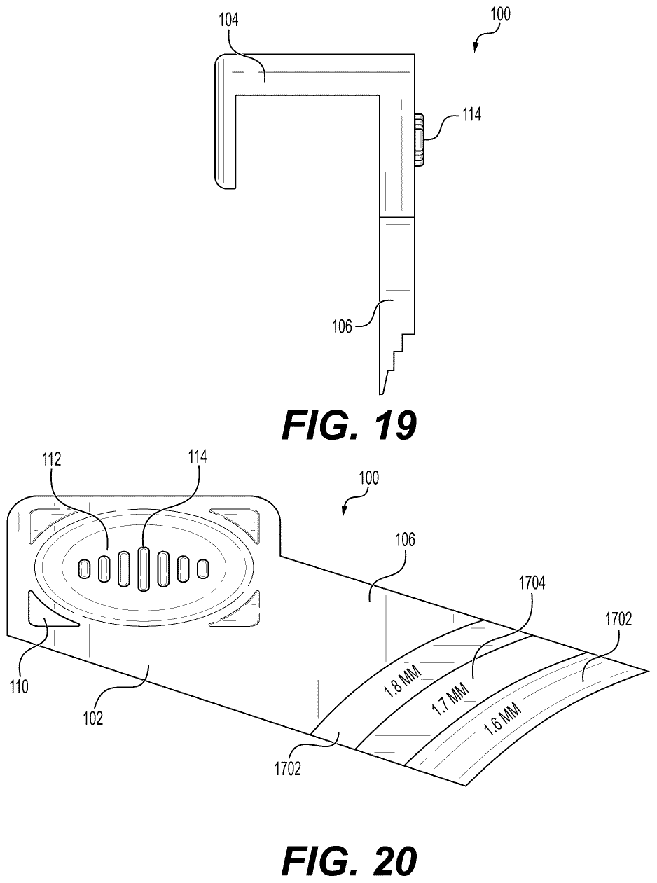

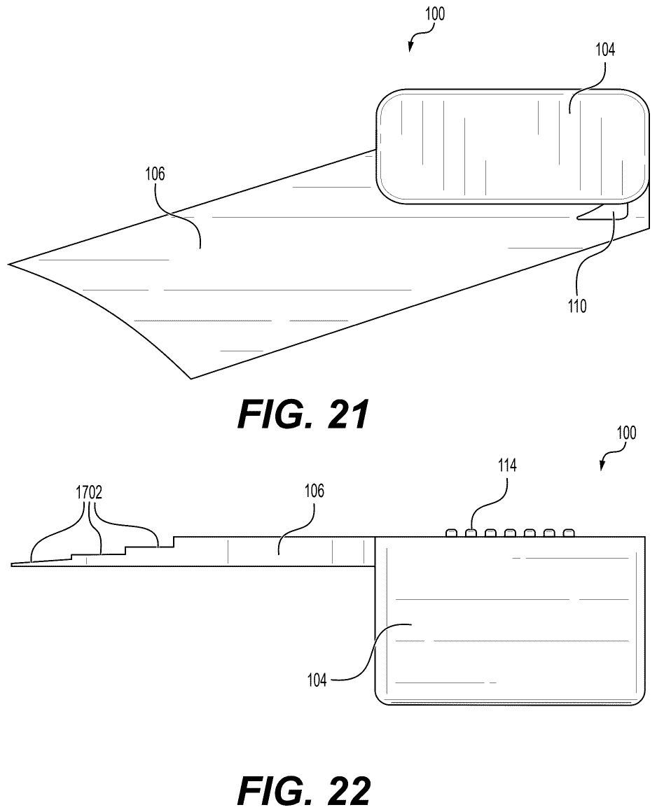

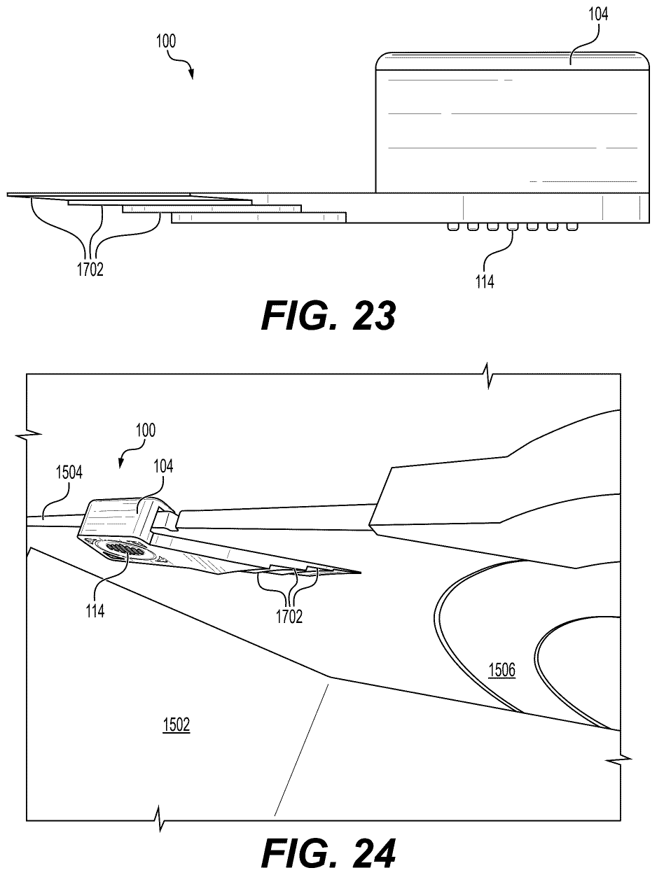

FIGS. 17-23 depict various views of an alternate embodiment of slicing guide 100 having one or more bevels 1702 along an outer edge of blade guide 106 as depicted in FIG. 17. In this embodiment, slicer hook 104 has a same shape as that of FIGS. 1-7. However, slicing guide body 102 has a same thickness as glade guide 106 because it is not used for setting the thickness of slicer 1502. Instead, the bevels 1702 are used as will be described later.

As shown in FIGS. 20, 22, and 23, the bevels 1702 are preferably “stepped” to ease removal once the slicer 1502 has been adjusted. Each bevel 1702 is preferably curved to contour to the curvature of slicer blade 1506. A front surface of each bevel 1702 can be labeled with a corresponding thickness label 1704 to which the slicer blade 1506 will be adjusted if that bevel is utilized. An advantage of the slicing guide 100 depicted in FIGS. 17-23 is that a single device can be used to set multiple thicknesses for slicer 1502. However, the user must ensure the correct bevel 1702 is utilized for the desired thickness.

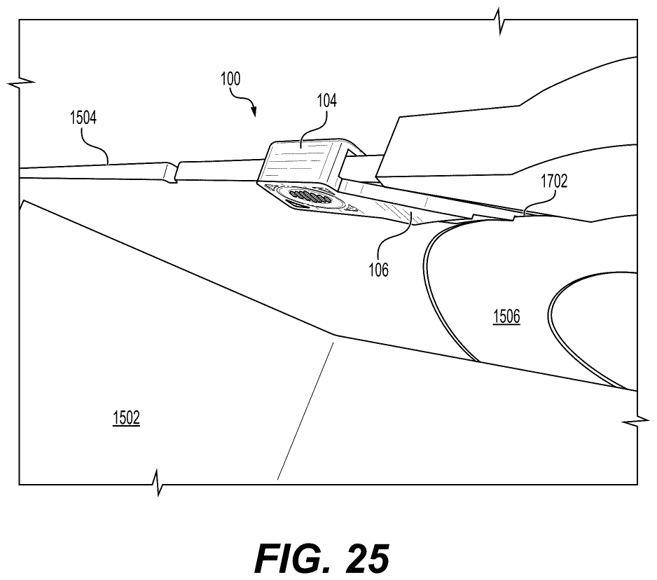

To utilize the slicing guide 100 of FIGS. 17-23, the slicer hook 104 is placed over the slicer edge 1504 as depicted in FIG. 24 after the slicer blade 1506 has been opened, preferably fully. The thickness of the slicer blade 1506 is then reduced/lessened until the slicer blade 1506 contacts the desired bevel 1702 as depicted in FIG. 25. The slicing guide 100 can then be removed from slicer 1502 since the thickness has been set and slicing can commence.

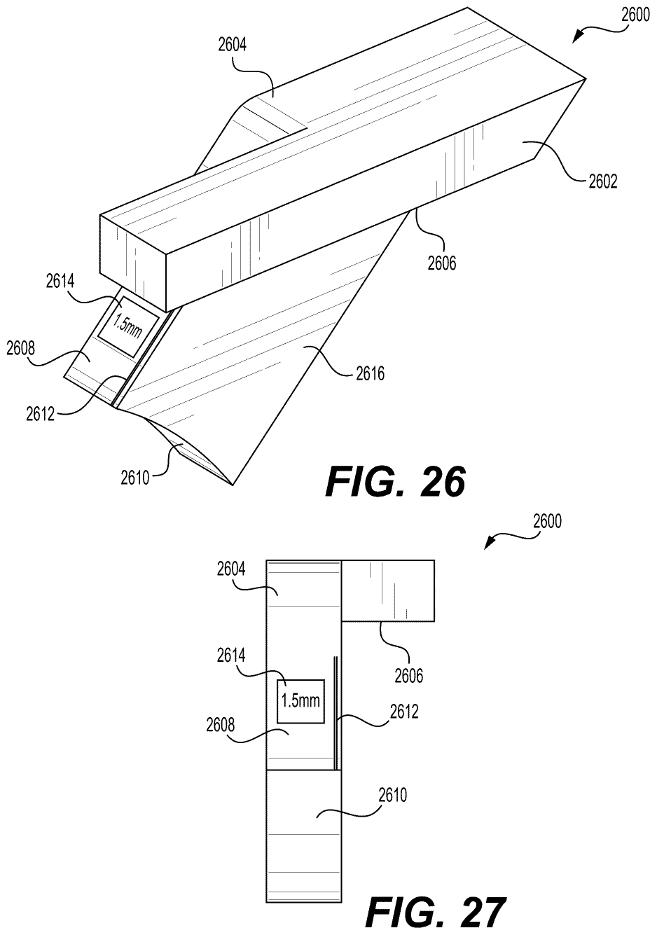

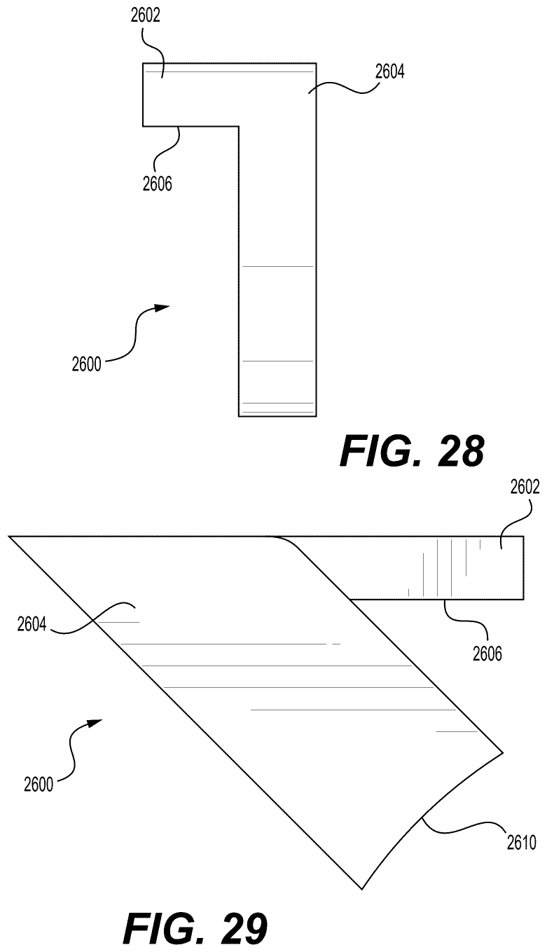

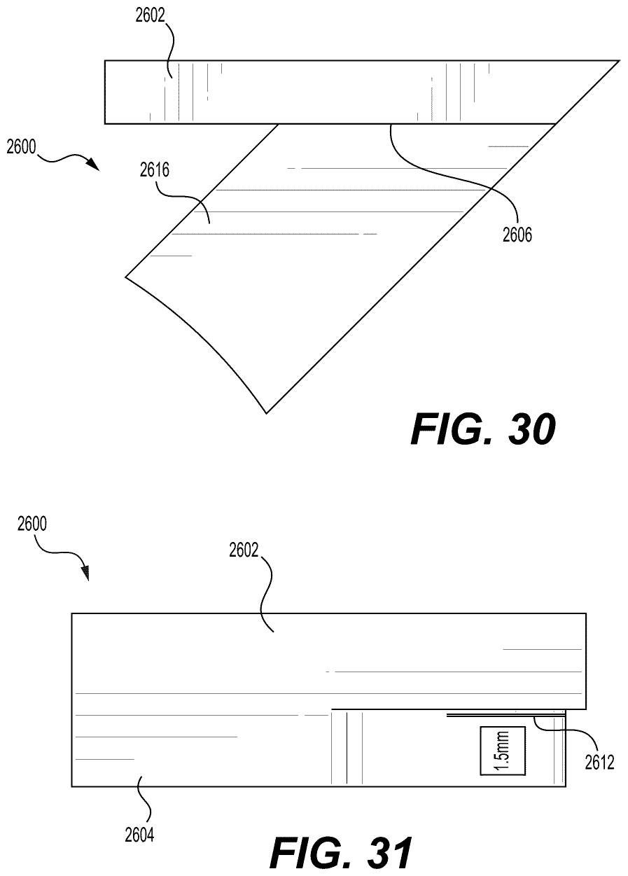

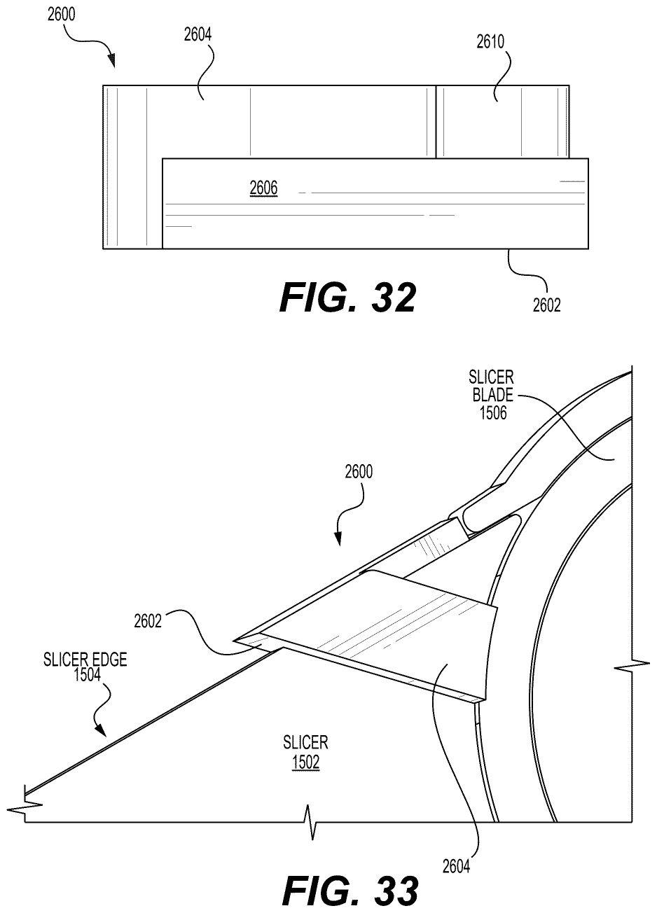

FIGS. 26-32 depict an embodiment of slicing guide 2600. As depicted, slicing guide 2600 generally comprises slicing guide rest 2602, slicing guide body 2604, guide face 2608, and curved face 2610. Preferably, slicing guide 2600 has a unitary construction and can be formed from a suitable food-grade metal or plastic (e.g., stainless steel or polyethylene). Because the slicing guide 2600 is designed to be used with a slicer 1502, it is preferably that the material is non-porous and hygienic to meet food safety requirements.

Slicing guide rest 2602 is similar to slicer hook 104 but does not have an extra lip to hook onto slicer edge 1504. Instead, flat bottom surface 2606 is designed to rest on slicer 1502 and be held in place while the slicer 1502 is adjusted to guide line 2612. Slicing guide rest 2602 is coupled to a top of slicing guide body 2604 as depicted in FIG. 26. It should be obvious to one of ordinary skill in the art that a width of flat bottom surface 2606 can be varied (e.g., even curved) to accommodate different models of slicers 1502.

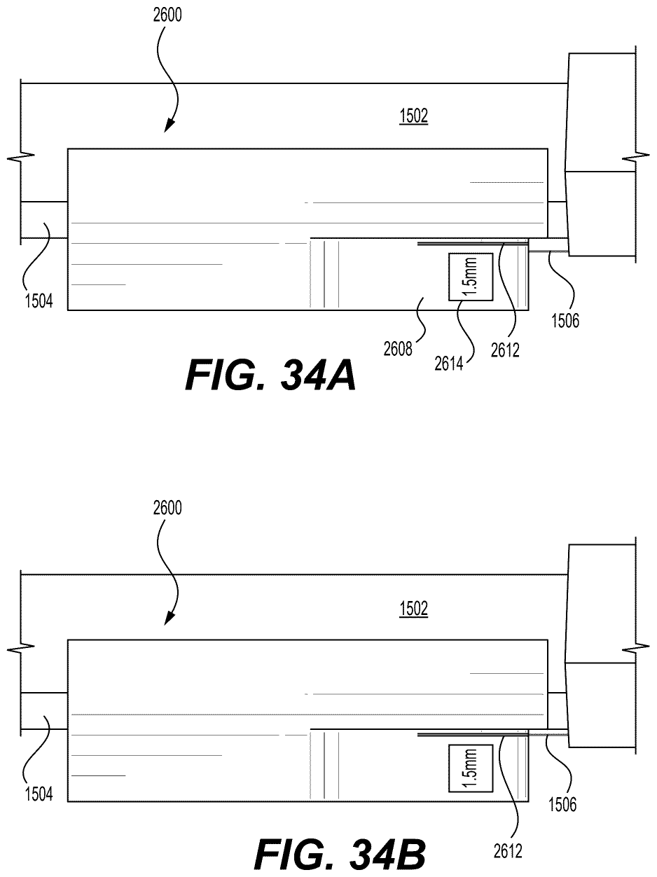

A leading edge of slicing guide body 2604 terminates at curved edge 2610 which has a curvature designed to align with a standard slicer blade 1506 (e.g., an 8″ blade used on a light-duty slicer or a 14″ blade used on a heavy-duty slicer). As will be described later, curved edge 2610 may contact slicer blade 1506 when the thickness is being set on slicer 1502. A rear surface 2616 of slicing guide body 2604 is generally planar and contacts the body of slicer 1502 when in use as depicted later in FIG. 33.

In use, the slicer blade 1506 is aligned with guide line 2612. A label 2614 may be utilized to identify the specific thickness for the guide line 2612 (e.g., 1.5 mm). In some embodiments slicing guide 2600 may have multiple guide lines 2612 with each guide line 2612 having a label for the different thicknesses. Generally, the thickness setting is only limited by a thickness of guide face 2608 since guide line 2612 appears on guide face 2608. Label 2614 may be engraved/embossed on the surface of guide face 2608 or may be printed and adhered as is known in the art. The location of label 2614 may also be varied to different locations on slicing guide 2600. Additional information, such as intended use (e.g., for sandwiches), may also be indicated on label 2614.

FIGS. 33, 34A, and 34B depict the steps used to adjust thickness of slicer 1502 using slicing guide 2600. As shown in FIG. 33, the flat bottom surface 2606 is placed over slicer edge 1504 and held in place in the vicinity of slider blade 1506. The user then adjusts slicer blade 1506 as depicted in FIGS. 34A and 34B until the slicer blade 1506 aligns with guide line 2612 (FIG. 34B). As previously described, multiple guide lines 2612 for multiple thicknesses may be indicated on guide face 2608.

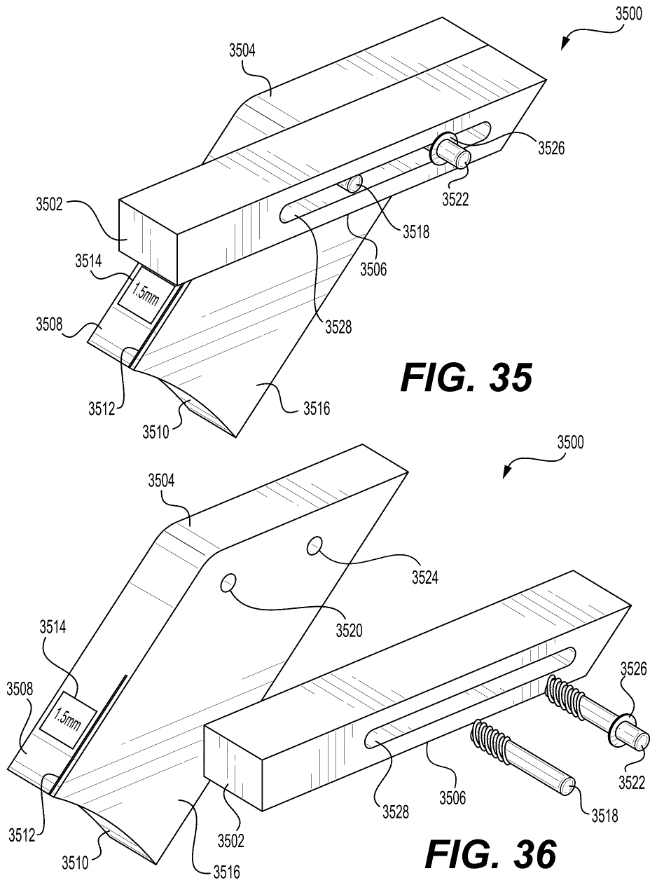

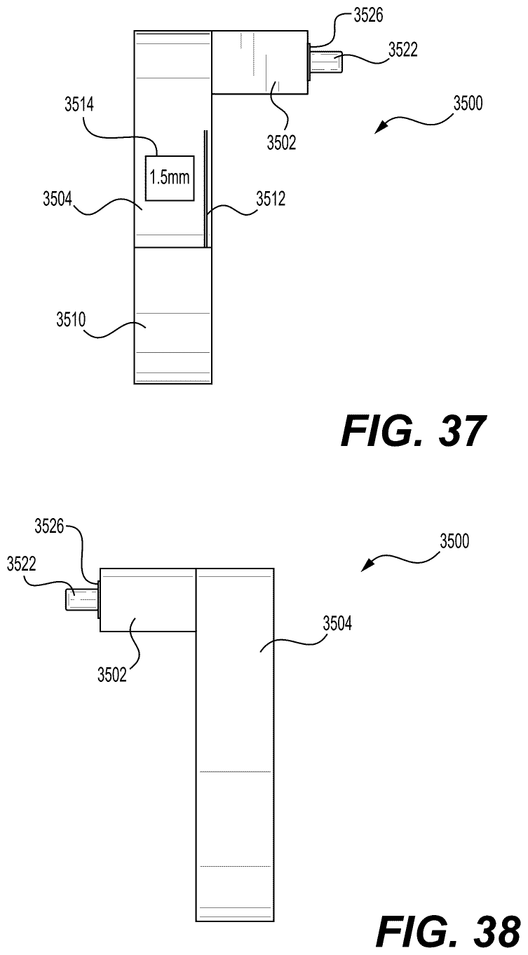

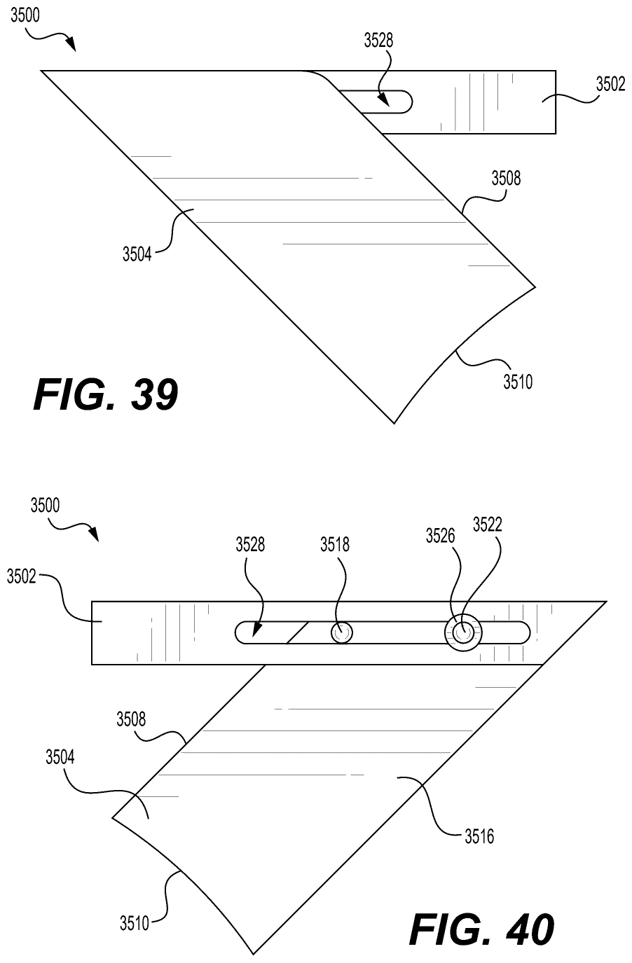

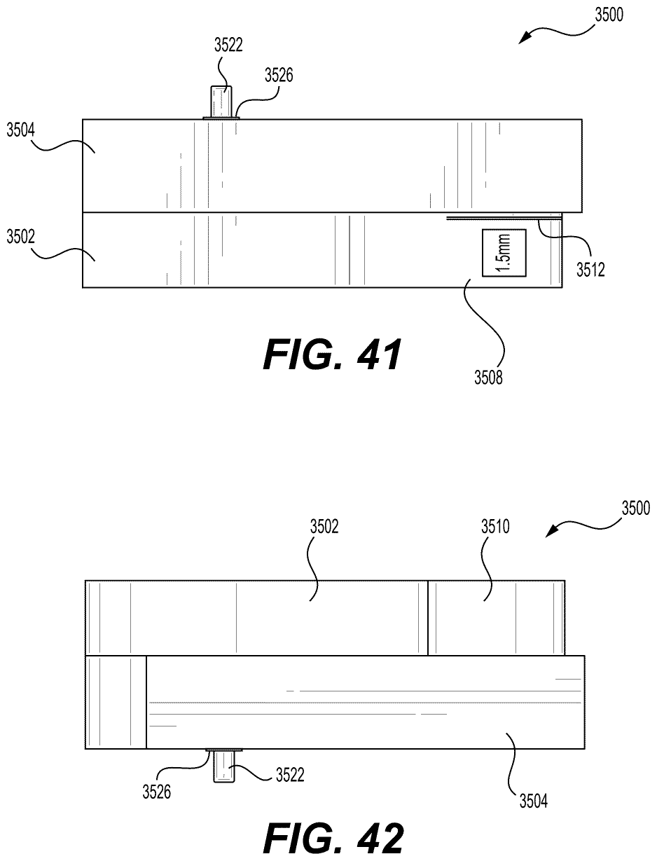

FIGS. 35-42 depict an embodiment of slicing guide 3500 which is adjustable. However, slicing guide 3500 is other utilized in the same manner as slicing guide 2600 when adjusting slicer 1502. In this embodiment, slicing guide body 3504 is formed separately from slicing guide rest 3502 and the two halves are adjustable with respect to each other. As depicted in the exploded view of FIG. 36, rear surface 3516 comprises two aligned screw holes 3524 with threads. Slicing guide rest 3502 has through slot 3528 which is generally formed as an obround longitudinal groove. To attach slicing guide rest 3502 to slicing guide body 3504, cylindrical guide 3518 is screwed into screw hole 3520 through slot 3528 and adjustment knob 3522 (having a similar shape) is screwed into screw hole 3524 through slot 3528. Adjustment knob 3522 comprises bearing surface 3526 that exerts a force against slicing guide rest 3502 as it is tightened.

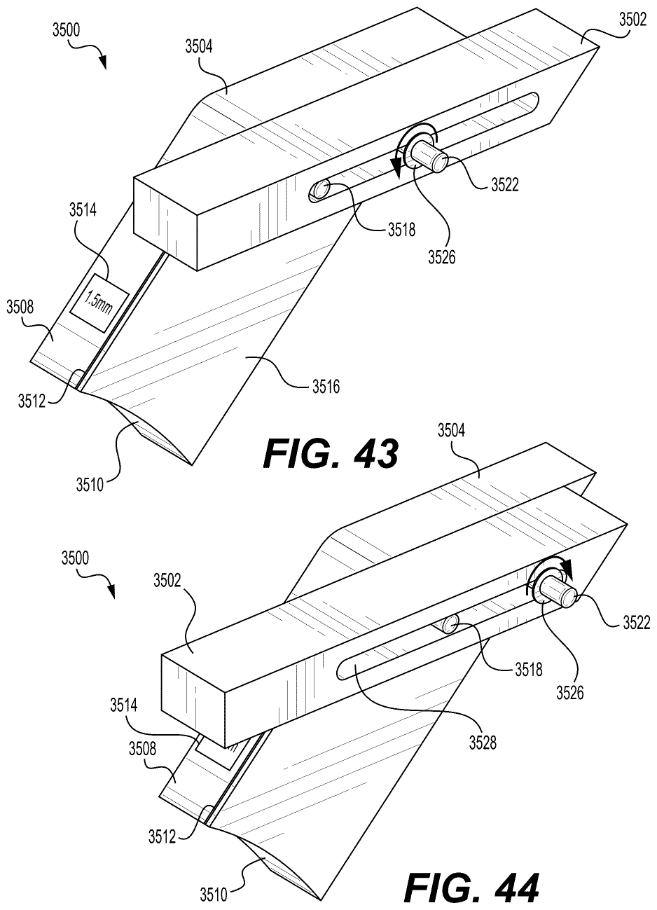

When adjustment knob 3522 is loosened (e.g., by rotating to the left) as depicted in FIG. 43, slicing guide rest 3502 can be adjusted horizontally with respect to slicing guide body 3504. The adjustment distance is limited by the spacing between cylindrical guide 3518 and adjustment knob 3522 as well as the length of slot 3528. After adjustment, adjustment knob 3522 is tightened as depicted in FIG. 44 so that the position of slicing guide rest 3502 is fixed with respect to slicing guide body 3504 during use. In some embodiments, and end of cylindrical guide 3518 may also comprise a similar bearing surface 3526 and adjustment knob 3522 and used in a similar manner as depicted in FIGS. 43-44.

The other components of slicing guide 3500 are similar to that of slicing guide 2600. Slicing guide 2600 generally comprises slicing guide rest 3502, slicing guide body 3504, guide face 3508, and curved edge 3510. Preferably, slicing guide rest 3502 and/or slicing guide body 3504 are formed from a suitable food-grade metal or plastic (e.g., stainless steel or polyethylene). Because the slicing guide 3500 is designed to be used with a slicer 1502, it is preferably that the material is non-porous and hygienic to meet food safety requirements.

Slicing guide rest 3502 is similar to slicer hook 104 but does not have an extra lip to hook onto slicer edge 1504. Instead, flat bottom surface 3506 is designed to rest on slicer 1502 and be held in place while the slicer 1502 is adjusted to guide line 3612. It should be obvious to one of ordinary skill in the art that a width of flat bottom surface 3506 can be varied (e.g., even made curved) to accommodate different models of slicers 1502.

A leading edge of slicing guide body 3504 terminates at curved edge 3510 which has a curvature designed to align with a standard slicer blade 1506 (e.g., an 8″ blade used on a light-duty slicer or a 14″ blade used on a heavy-duty slicer). As will be described later, curved edge 3510 may contact slicer blade 1506 when the thickness is being set on slicer 1502.

In use, the slicer blade 1506 is aligned with guide line 3512. A label 3514 may be utilized to identify the specific thickness for the guide line 3512 (e.g., 1.5 mm). In some embodiments slicing guide 3500 may have multiple guide lines 3512 with each guide line 3512 having a label for the different thicknesses. Generally, the thickness setting is only limited by a thickness of guide face 3508 since guide line 3512 appears on guide face 3508. Label 3514 may be engraved/embossed on the surface of guide face 2608 or may be printed and adhered as is known in the art. The location of label 3514 may also be varied to different locations on slicing guide 3500. Additional information, such as intended use (e.g., for sandwiches), may also be indicated on label 3514.

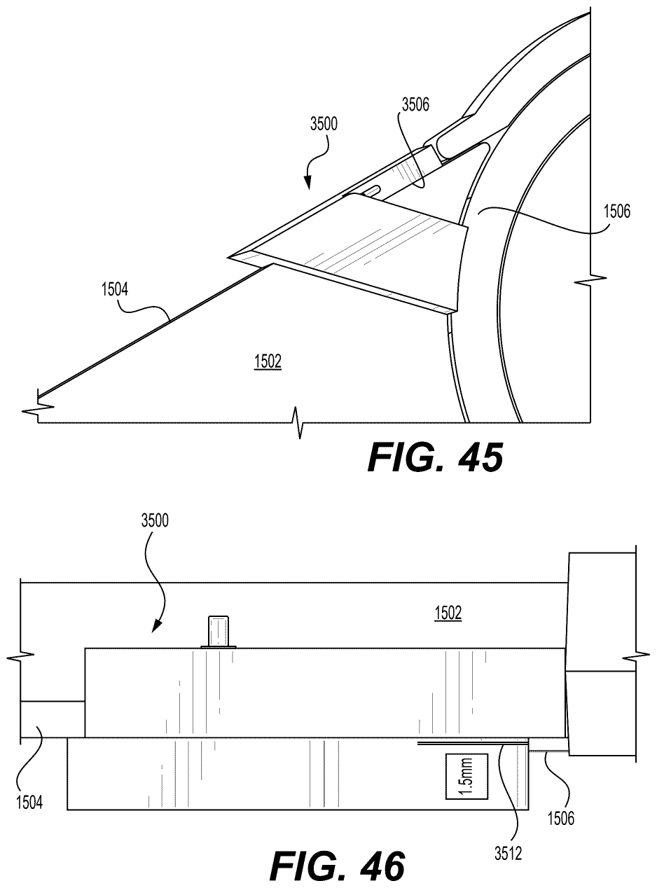

FIGS. 45-46 depict the steps used to adjust thickness of slicer 1502 using slicing guide 3500. As shown in FIG. 45, the flat bottom surface 3506 is placed over slicer edge 1504 and held in place in the vicinity of slider blade 1506. The user then adjusts slicer blade 1506 as depicted in FIGS. 36 and 34B until the slicer blade 1506 aligns with guide line 3612. As previously described, multiple guide lines 3612 for multiple thicknesses may be indicated on guide face 2608.

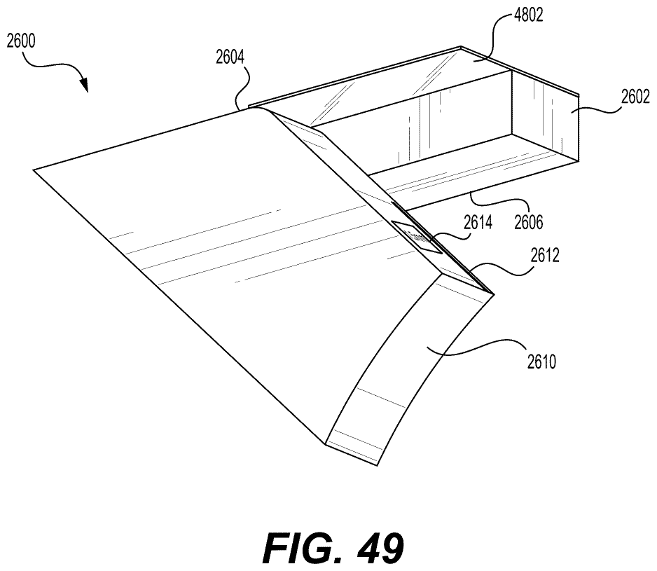

FIG. 48-49 depict an alternate embodiment of slicing guide 2600. In this embodiment, a magnifying glass 4802 has been added over the top of guide face 2608 so that a user can better judge the alignment of guide line 2612 with slicer blade 1506. As should be obvious to one of ordinary skill in the art, the location of magnifying glass 4802 may be varied as needed. For example, magnifying glass 4802 may be inserted and glued into grooves on guide face 2608 and a side of slicing guide rest so it sits below a top surface of slicing guide rest 2602.

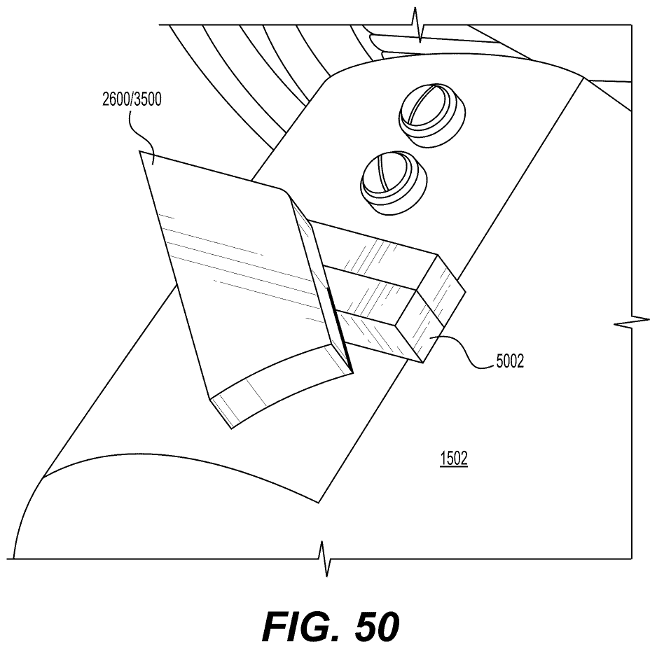

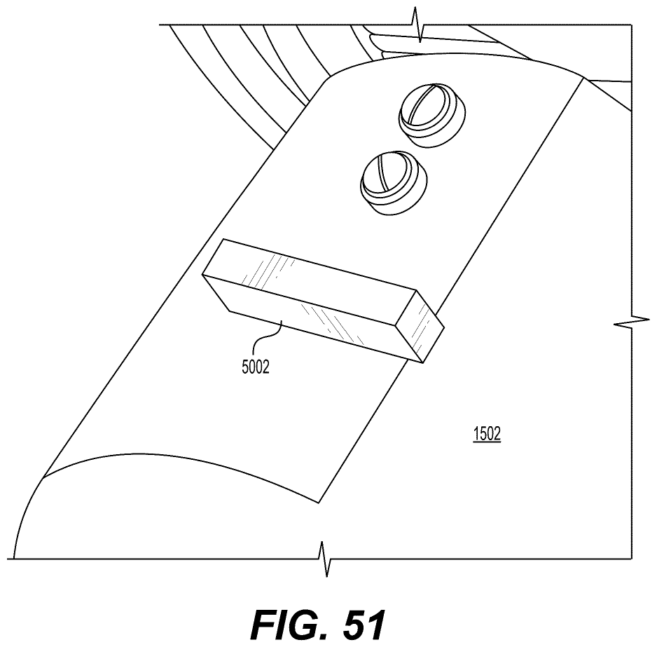

FIGS. 50-51 depict slicing guide rest 5002 being used with slicing guide 2600 and/or 3500. Generally, slicing guide rest 5002 is made from a rectangular block of material that is adhered or affixed to slicer 1502. For example, the slicing guide rest 5002 may be adhered to slicing guide rest or magnets may be utilized. It should be obvious to one of ordinary skill in the art that any attachment method may be utilized. Flat bottom surface 2506 or 3506 generally has a same thickness as slicing guide rest 5002 and can be used to store slicing guide 25000 or 3500 when not in use as depicted in FIG. 50.

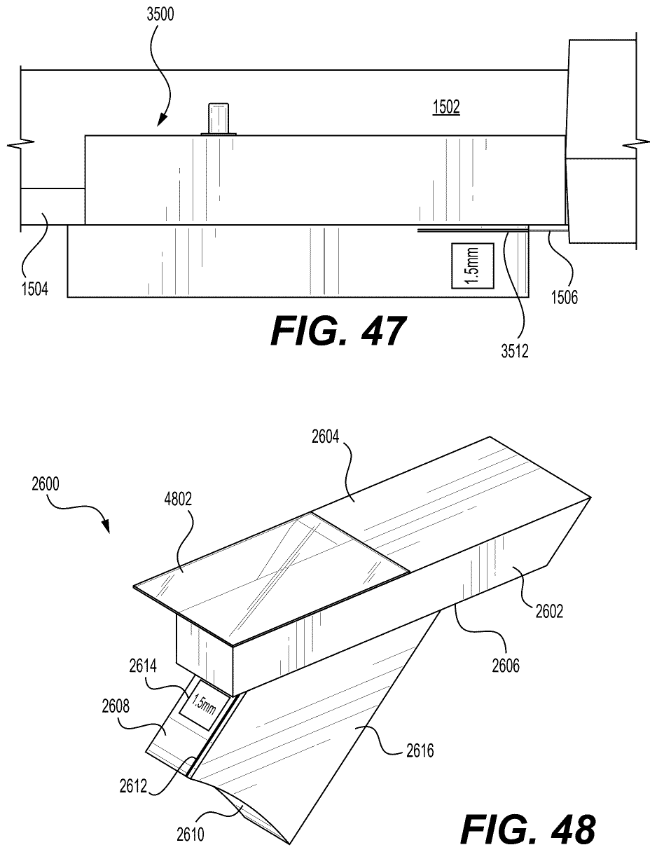

Although the embodiments depicted in FIGS. 26-50 are shown as plain, they may be modified to include thumb wells 112 and/or finger grips 114 as depicted in FIG. 4. An edge of the slicer body may also include a thru hole 110 for hanging the slicing guides 2600 or 3500.

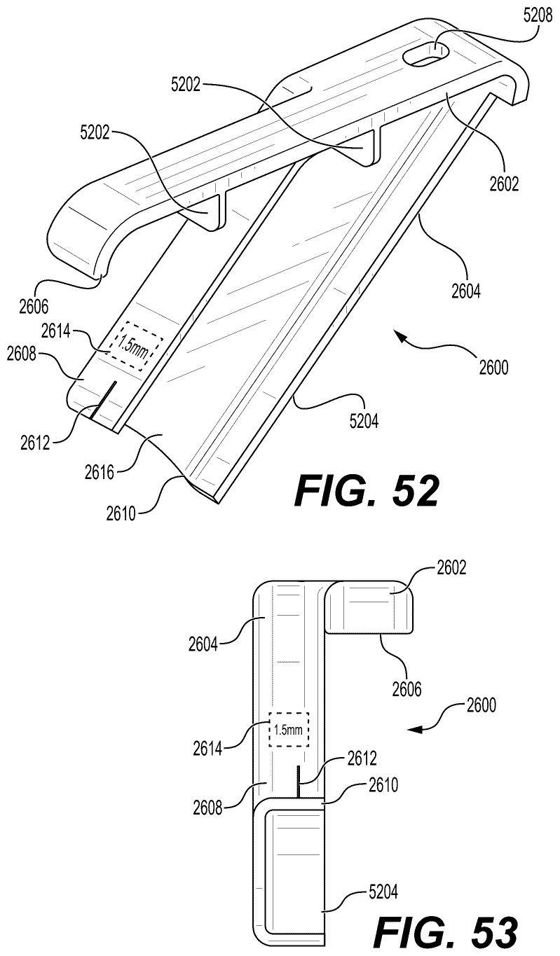

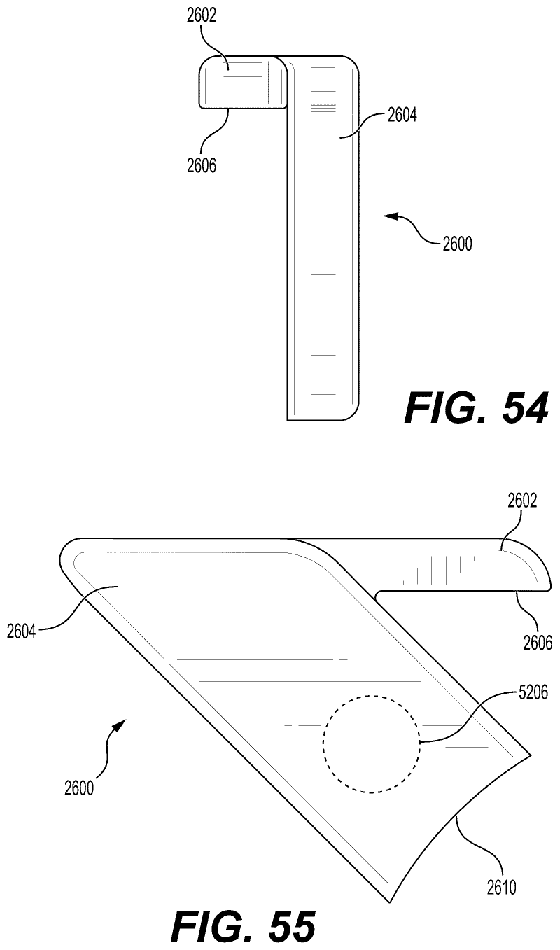

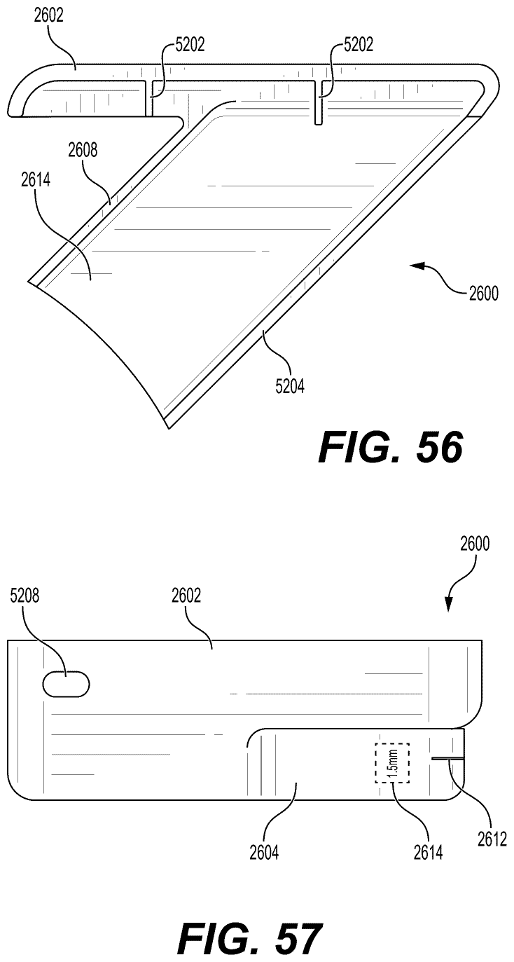

FIGS. 52-58 depict another embodiment of slicing guide 2600. As depicted, slicing guide 2600 generally comprises slicing guide rest 2602, slicing guide body 2604, guide face 2608, and curved face 2610. Preferably, slicing guide 2600 can be formed from injection molding or 3D printing as a unitary construction and can be formed from a suitable food-grade metal or plastic (e.g., stainless steel or polyethylene). Because the slicing guide 2600 is designed to be used with a slicer 1502, it is preferably that the material is non-porous and hygienic to meet food safety requirements.

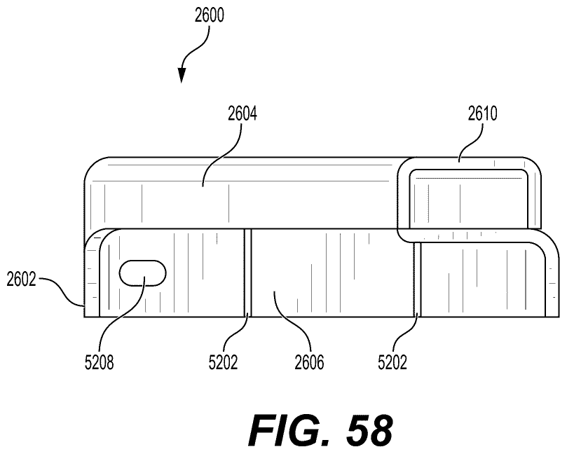

Slicing guide rest 2602 is similar to slicer hook 104 but does not have an extra lip to hook onto slicer edge 1504. Instead, as depicted in FIGS. 52 and 58, bottom surface 2606 is formed from a plurality of ribs 5202 extending downward from a top surface of slicing guide rest 2602 a predetermined distance. In contrast to the slicing guide 2600 depicted in FIG. 26, the space between ribs 5202 is recessed or empty to provide rigidity while reducing the amount of material required to manufacture slicing guide 2600. At least one rib 2602 is coupled to both slicing guide rest 2602 and slicing guide body 2604. Since ribs 5202 are the same height, they are designed to rest flat on a body of slicer 1502 and be held in place while the slicer 1502 is adjusted to guide line 2612. Slicing guide rest 2602 is coupled to slicing guide body 2604 as depicted in FIG. 52. It should be obvious to one of ordinary skill in the art that a width of flat bottom surface 2606 or ribs 5202 can be varied (e.g., even curved) to accommodate different models of slicers 1502.

A leading edge of slicing guide body 2604 terminates at curved edge 2610 which has a curvature designed to align with a standard slicer blade 1506 (e.g., an 8″ blade used on a light-duty slicer or a 14″ blade used on a heavy-duty slicer). As will be described later, curved edge 2610 may contact slicer blade 1506 when the thickness is being set on slicer 1502. A rear surface 2616 of slicing guide body 2604 is formed from guide face 2608 and body ridge 5204. The edge of guide face 2608 and body ridge 5204 are planar contacts the body of slicer 1502 when in use as depicted later in FIG. 33.

In use, the slicer blade 1506 is aligned with guide line 2612. A label 2614 may be utilized to identify the specific thickness for the guide line 2612 (e.g., 1.5 mm). In some embodiments slicing guide 2600 may have multiple guide lines 2612 with each guide line 2612 having a label for the different thicknesses. Generally, the thickness setting is only limited by a thickness of guide face 2608 since guide line 2612 appears on guide face 2608. Label 2614 may be engraved/embossed on the surface of guide face 2608 or may be printed and adhered as is known in the art. The location of label 2614 may also be varied to different locations on slicing guide 2600. Additional information, such as intended use (e.g., for sandwiches), may also be indicated on label 2614.

A front surface of slicing guide body 2604 may comprise labeling 5206 to be used to add a logo or brand name to the slicing guide 2600 for easier identification. Further, since an interior of slicing guide rest 2602 is open between ribs 2602, an opening 5208 may be provided to hang or store slicing guide 2600.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A slicing guide comprising:
a slicing guide rest,
wherein a bottom of the slicing guide rest is flat; and
a slicing guide body coupled to the slicing guide rest at an acute angle,
wherein the slicing guide rest is coupled to a rear of the slicing guide body at a first end of the slicing guide body; and
a guide line on a top surface of the slicing guide body.

2. The slicing guide according to claim 1,
wherein the guide line extends to a second end of the slicing guide body opposite the first end of the slicing guide body.

3. The slicing guide according to claim 1,
wherein a top surface of the slicing guide rest is coplanar with a top surface of the slicing guide body.

4. The slicing guide according to claim 1, wherein a second end of the slicing guide body has a radius of curvature of 200-500 mm.

5. The slicing guide according to claim 1,
wherein the slicing guide rest and the slicing guide body are integrally formed as a unitary body.

6. The slicing guide according to claim 1, further comprising:
a thickness label adjacent the guide line on the top surface of the slicing guide body.

7. The slicing guide according to claim 6,
wherein the slicing guide body has a thickness greater than a thickness indicated by the thickness label.

8. The slicing guide according to claim 1, further comprising:
a second guide line on the top surface of the slicing guide body parallel to the guide line.

9. The slicing guide according to claim 1, further comprising:
an opening extending through the slicing guide rest adjacent to the first end of the slicing guide body.

10. The slicing guide according to claim 1,
wherein the bottom of the slicing guide rest is formed from a plurality of ribs extending downward from a top surface of the slicing guide rest a predetermined distance.

11. The slicing guide according to claim 1,
wherein a rear edge of the slicing guide body extending away from the slicing guide rest is flat.

12. The slicing guide according to claim 11,
wherein the rear edge of the slicing guide body is formed from a rear edge of the top surface of the slicing guide body parallel to a rear edge of the bottom surface of the slicing guide body.

13. The slicing guide according to claim 1,
wherein the slicing guide body or the slicing guide rest are formed using injection molding or three-dimensional printing.

14. The slicing guide according to claim 1,
wherein a front surface of the slicing guide body comprises a branding label.

15. The slicing guide according to claim 1,
wherein a thickness of the slicing guide body is greater than a thickness of the slicing guide rest.
